(19) United States
(12) Patent Application Publication
(10) Pub. No.: US 2026/0010431 A1
(43) Pub. Date: Jan. 8, 2026

(54) BATCH UPDATE PROCESSING IN LOGICAL TO PHYSICAL (L2P) MANAGEMENT FOR FOLDING OPERATIONS IN MEMORY DEVICES

(71) Applicant: MICRON TECHNOLOGY, INC., Boise, ID (US)

(72) Inventors: Ritesh Tiwari, Bangalore (IN); Paul Stonelake, Santa Clara, CA (US); Byron D. Harris, Mead, CO (US); John Kane, Westminster, CO (US)

(21) Appl. No.: 19/256,774

(22) Filed: Jul. 1, 2025

Related U.S. Application Data
(60) Provisional application No. 63/667,362, filed on Jul. 3, 2024.

(51) Int. Cl. G06F 11/10; G06F 12/02

(52) U.S. Cl. CPC G06F 11/1016; G06F 11/1068; G06F 12/0246

(57) ABSTRACT

A system includes a memory device; and a processing device, operatively coupled with the memory device, to perform operations including retrieving data stored in an array of source memory cells on the memory device; writing the data and a plurality of journal entries to an array of destination memory cells on the memory device, wherein each journal entry of the plurality of journal entries corresponds to a respective write unit of a plurality of write units of the data; responsive to determining that the writing is completed, performing a logical to physical (L2P) update check on each data unit of a plurality of data units of the data using the plurality of journal entries, wherein the L2P update check determines whether no change to the data unit stored in the array of source memory cells occurs during writing the data; detecting an event during performing the L2P update check; and performing an action associated with the event.

### RELATED APPLICATIONS

This application claims the benefit of U.S. Provisional Patent Application No. 63/667,362, filed Jul. 3, 2024, the entire contents of which are incorporated by reference herein.

### TECHNICAL FIELD

Embodiments of the disclosure relate generally to memory sub-systems, and more specifically, relate to batch update processing in logical to physical (L2P) management for folding operations in memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIGS. 2 and 3 illustrate block diagrams of systems that implement logical to physical (L2P) management for folding operations in memory devices in accordance with some embodiments of the present disclosure.

FIGS. 4 and 5 illustrate example source memory cells in folding operations in accordance with some embodiments of the present disclosure.

FIGS. 6A and 6B illustrate example destination memory cells in folding operations in accordance with some embodiments of the present disclosure.

FIG. 7 illustrates example logical to physical (L2P) journals in accordance with some embodiments of the present disclosure.

FIG. 8 illustrates example logical to physical (L2P) data structures in accordance with some embodiments of the present disclosure.

FIG. 9 illustrates example records of batch update processing in accordance with some embodiments of the present disclosure.

FIG. 10 is a flow diagram of an example method to perform batch update processing in logical to physical (L2P) management for folding operations in memory devices in accordance with some embodiments of the present disclosure.

FIG. 11 is a block diagram of an example computer system in which embodiments of the present disclosure may operate.

### DETAILED DESCRIPTION

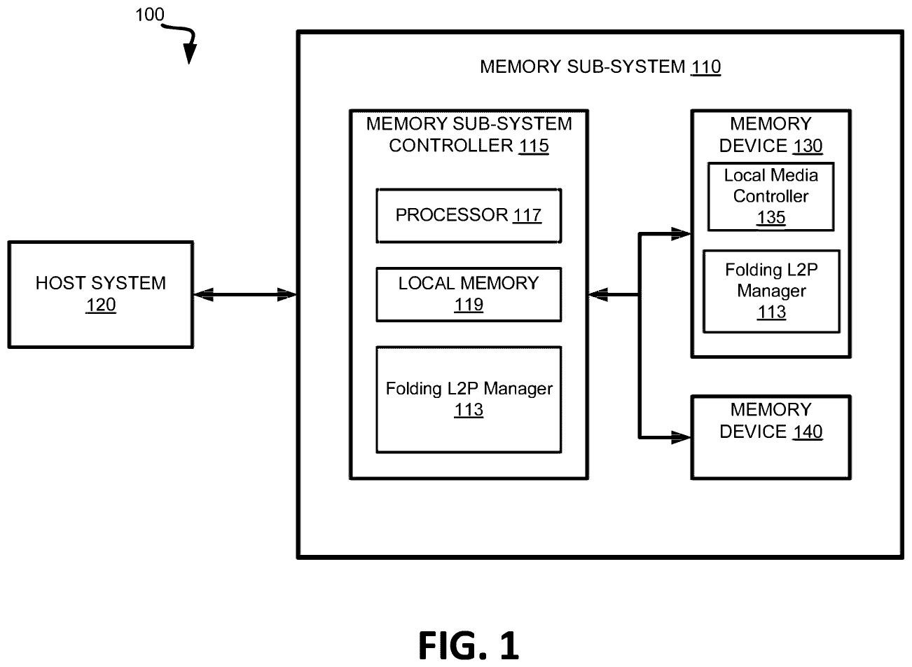

Aspects of the present disclosure are directed to batch update processing in logical to physical (L2P) management for folding operations in memory devices. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional grid. The memory cells are etched onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

As described above, a die can contain one or more planes. A memory sub-system can use a striping scheme to treat various sets of data as units when performing data operations (e.g., write, read, erase, etc.). A die stripe refers to a collection of planes that are treated as one unit when writing, reading, or erasing data. A controller of a memory device (i.e., a memory sub-system controller, a memory device controller, etc.) can execute the same operation, in parallel, at each plane of a dice stripe. A block stripe is a collection of blocks, at least one from each plane of a die stripe, that are treated as a unit. The blocks in a block stripe can be associated with the same block identifier (e.g., block number) at each respective plane. A page stripe is a set of pages having the same page identifier (e.g., the same page number), across a block stripe, and treated as a unit.

One type of cell is a single level cell (SLC), which stores 1 bit per cell and defines 2 logical states (“states”) (“1” or “L0” and “0” or “L1”) each corresponding to a respective V_{T} level. For example, the “1” state can be an erased state and the “0” state can be a programmed state (L1). Another type of cell is a multi-level cell (MLC), which stores 2 bits per cell and defines 4 states (“11” or “L0”, “10” or “L1”, “01” or “L2” and “00” or “L3”) each corresponding to a respective V_{T} level. For example, the “11” state can be an erased state and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”) each corresponding to a respective V_{T} level. For example, the “111” state can be an erased state and each of the other states can be a respective programmed state. Another type of a cell is a quad-level cell (QLC), which stores 4 bits per cell and defines 16 states L0-L15, where L0 corresponds to “1111” and L15 corresponds to “0000”. Another type of cell is a penta-level cell (PLC), which stores 5 bits per cell and defines 32 states. Other types of cells are also contemplated. Thus, an n-level cell can use 2ⁿ levels of charge to store n bits. A memory device can include one or more arrays of memory cells such as SLCs, MLCs, TLCs, QLCs, PLCs, etc. or any combination of such. For example, a memory device can include an SLC portion, and an MLC portion, a TLC portion, a QLC portion, or a PLC portion of cells.

Each type of memory cell (e.g., SLCs, MLCs, TLCs and QLCs) can exhibit different characteristics and advantages. For example, an SLC can have a lower read latency (e.g., how long it takes for data stored at the SLC to be read), a faster programming time (e.g., how long it takes to program data received from the host system to the cell for storage) and a greater reliability for data stored at the SLC than the other types of memory cells. Although SLCs offer superior performance characteristics, manufacturing memory devices that include only SLC memory cells can be less cost-effective in comparison with memory devices having higher density cells (e.g., MLCs, TLCs and QLCs), which store more bits per cell. Accordingly, some memory cells can be configured as SLCs, while the rest of the memory cells can be higher density cells. Data can be first written to the SLC portion of the memory device and later transferred to a higher density portion of the memory device when the memory sub-system is not busy servicing host requests. The use of SLC cells in this way can be termed a “SLC cache.” The SLC cache provides a balance between the speed of SLC memory cells with the storage capacity of higher density memory cells. In some memory implementations, as the device fills up, memory cells configured as SLC cache are migrated to higher density memory cells to increase data storage capacity.

A host system can initiate a memory access operation (e.g., a programming or write operation, a read operation, an erase operation, etc.) on a memory sub-system. For example, the host system can transmit a request to a memory sub-system controller, to program data to and/or read data from a memory device of the memory sub-system. Such data is referred to herein as “host data.” The memory sub-system controller can execute one or more operations to access the host data in accordance with the request. Host data can be encoded using error-correcting code (ECC)) to correct data errors that can occur during transmission or storage. In particular, the host data can be encoded using redundancy metadata (e.g., parity data such as one or more parity bits) to form a codeword. The parity data allows the memory sub-system controller to detect a number of errors that may occur anywhere in the host data, and often to correct these errors without retransmission.

In some systems, a memory sub-system can routinely perform data integrity checks to verify that the data stored at the block can be reliably read. In an example, the memory sub-system controller can select a block and perform the data integrity check on some to all of the pages of the block. During the data integrity check, which can measure and collect information about error rates associated with data, values of a data state metric are determined for data stored at the block. “Data state metric” herein shall refer to a quantity that is measured or inferred from the state of data stored on a memory device. Specifically, data state metrics may reflect the state of the temporal voltage shift, the degree of read disturb, and/or other measurable functions of the data state. A composite data state metric is a function (e.g., a weighted sum) of a set of component state metrics. One example of a data state metric is bit error count (BEC). Another example of a data state metric is residual bit error rate (RBER). The RBER corresponds to a number of bit errors per unit of time that the data stored at the data block experiences (e.g., BEC/total bits read). A data state metric value exceeding a transfer threshold criterion can trigger a media management operation (e.g., a folding operation).

A folding operation involves copying data from a source management unit (e.g., a block, superblock, a page, etc.) to an available management unit on the memory device. A folding operation can be performed in various scenarios. In one instance, the folding operation includes retrieving data stored in the source management units (e.g., as a cache) and programming the data on certain types of memory cells in the destination management units.

In another instance, the folding operations occurs as garbage collection, for example, in a memory device such as quadruple-level cell (QLC) memory device. Garbage collection is a process to recover free space by relocating pages with data to new blocks, and erasing old blocks. Specifically, a block can include valid data pages and data pages that are no longer needed (e.g., stale pages). Garbage collection generally involves copying only the valid data pages from a source block to a destination block and then erasing the source block to free the space.

In order to isolate, from the host system, various aspects of physical implementations of memory devices employed by memory sub-systems, the memory sub-system can maintain a data structure that maps each logical address to a corresponding physical address. In some implementations, the physical address can include channel identifier, die identifier, plane identifier, block identifier, page identifier, etc. The mapping data structure is referred to herein as a logical-to-physical (L2P) data structure. The L2P data structure can be maintained by the firmware of the memory sub-system controller and can be stored on one or more non-volatile memory devices of the memory sub-system, or can at least partially be cached by one or more volatile memory devices of the memory sub-system to improve the overall efficiency of the data transfer between a host system and a memory sub-system. In some cases, updating the L2P data structure from mapping the source location to the destination location can be performed only after the folding operation is completed, and other operations may perform during the folding operation such that the mapping cannot be correctly updated for the folding operation. Further, updating the L2P data structure may also need to handle the situations including error detection in metadata and power loss during updating.

Aspects of the present disclosure address the above and other deficiencies by utilizing a conditional update of the L2P data structure for folding operation and implementing a firmware to manage the conditional update including handling events that occur during the conditional update, where the folding operation migrates host data stored at a particular number of data locations of the memory sub-system (“source memory arrays” such as one or more logical units (LUNs) (e.g., a die, a plane, a block, a page)) to other data locations of the memory sub-system (“destination memory arrays” such as one or more logical units (LUNs) (e.g., a die, a plane, a block, a page)). The conditional update of the L2P data structure refers to updating the L2P data structure associated with data involved in the folding operation, from mapping logical address of the data to source physical address to mapping logical address of the data to destination physical address, only when a condition (e.g., a threshold criterion) is satisfied.

Specifically, the firmware (e.g., a folding L2P manager) running on a controller of a memory sub-system or a memory device can retrieve valid data from source memory arrays. The firmware can write the retrieved data to destination memory arrays, and write journal entries associated with the retrieved data to the destination memory arrays. Each journal entry may correspond to a respective portion of the retrieved data (i.e., “corresponding data,” which can be referred to “a respective write unit of write units of the retrieved data”) and specifies the destination location of corresponding data as it journals the writing of corresponding data. Each journal entry may further specify the source location of corresponding data, which can be used later to compare with the threshold criterion for the conditional update determination.

Responsive to determining that writing the retrieved data is completed, the firmware may perform L2P update check by retrieving the journal entries and determining, for each journal entry, whether a source location specified in the journal entry matches a corresponding L2P entry in the L2P data structure. At this point, the corresponding L2P entry of the L2P data structure still maps the logical address of the corresponding data to source physical address as it is before performing the folding operation. The purpose of this L2P update check is to check the corresponding data involved in the folding operations is intact during the folding operations, that is, no other host operations are performed to the corresponding data stored in the source locations while the folding operation is in process. Upon determining that the source location specified in the journal entry matches a corresponding L2P entry in the L2P data structure, the firmware may update the corresponding L2P entry in the L2P data structure, where the updated corresponding L2P entry maps the logical address of the corresponding data to destination physical address. In some implementations, instead of updating the L2P entry one by one, the firmware may update a batch of the L2P entries in the L2P data structure upon determining that, for each journal entry, the source location specified in the journal entry matches a corresponding L2P entry of the batch of the L2P entries in the L2P data structure. In some implementations, the batch of the L2P entries corresponds to the entire retrieved data. In some implementations, the batch of the L2P entries corresponds to partial of the retrieved data.

During performing the L2P update check, the firmware may detect an event that affects the performance of the L2P update check and perform an action associated with the event. In some implementations, the firmware may maintain a queue to keep track of requests of the L2P update check on the data, wherein the L2P update check may be performed in data granularity of a block stripe, a page stripe, a write unit, a set of data units, etc. In some implementations, the firmware may maintain an update record to keep track of the performance and result of the L2P update check, such as a result of performing the L2P update check on a data unit of the data or a set of data units that is associated with a set of journal entries. In some implementations, the firmware may perform the action associated with the event based on the update record.

In some implementations, the event is an occurrence of uncorrectable error (e.g., uncorrectable ECC). The firmware may detect that an uncorrectable error occurs during retrieving a first journal entry of the journal entries, and skip performing the L2P update check on one or more data units associated with the first journal entry and resume the L2P update check on the rest of journal entries.

In some implementations, the event is an occurrence of a controlled power down. The controlled power down provides a limited amount of backup power to finish certain operations in the event of power down. The firmware may detect that a controlled power down occurs during performing the L2P update check on one or more data units associated with a first journal entry of the journal entries, use a backup power to continue performing and finishing the L2P update check on the one or more data units associated with the first journal entry, and upon detecting a power up event, resume the L2P update check on the rest of journal entries (e.g., based on the queue or update record described above).

In some implementations, the event is an occurrence of an asynchronous power loss (APL). The asynchronous power loss refers to the power loss occurs while there is still “in flight” data that has been either requested or transmitted through components of the system or pending in a component of the system to be written or retrieved and there is insufficient power-sustaining time to permit the system to complete the pending operations. The firmware may detect that an asynchronous power loss occurs during performing the L2P update check on one or more data units associated with a first journal entry of the journal entries, record the first journal entry (e.g., in the queue or update record described above), and upon detecting a power on event, resume the L2P update check on the first journal entry.

Advantages of the present disclosure include managing the L2P mapping for folding operations including handling occurrence of events associated with errors and/or power loss during the batch update of the L2P data structure. The conditional update of the L2P data structure prevents the situation in which the same data is migrated multiple times. Updating the L2P entries in batch also decreases the latency compared to updating the L2P entries one by one. Various aspects of the above referenced methods and systems are described in details herein below by way of examples, rather than by way of limitation.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, memory sub-system 110 includes a folding L2P manager 113 that can manage the L2P data structure for folding operations. In some embodiments, memory sub-system controller 115 includes at least a portion of folding L2P manager 113. In some embodiments, folding L2P manager 113 is part of host system 110, an application, or an operating system. In other embodiments, local media controller 135 includes at least a portion of folding L2P manager 113 and is configured to perform the functionality described herein. Further details with regards to the operations of folding L2P manager 113 are described below.

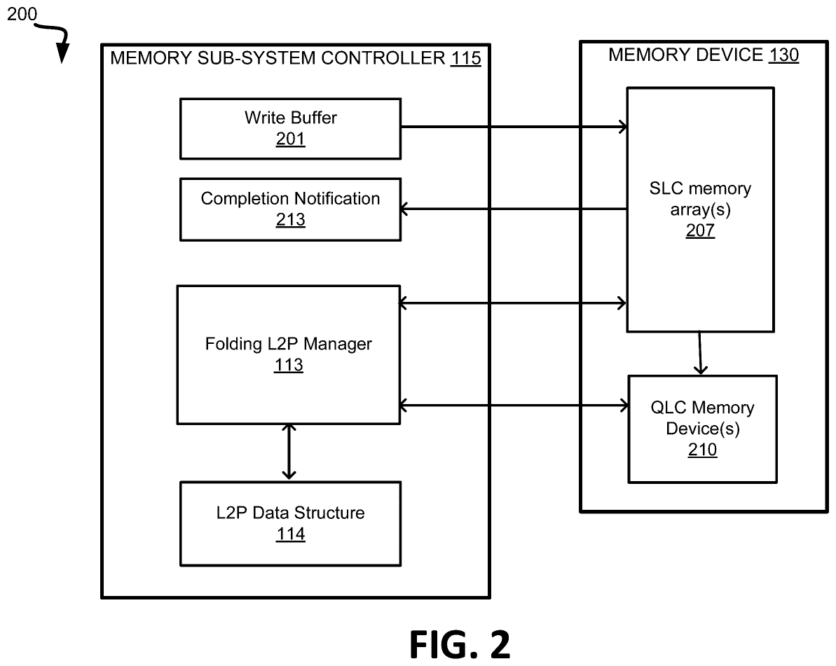

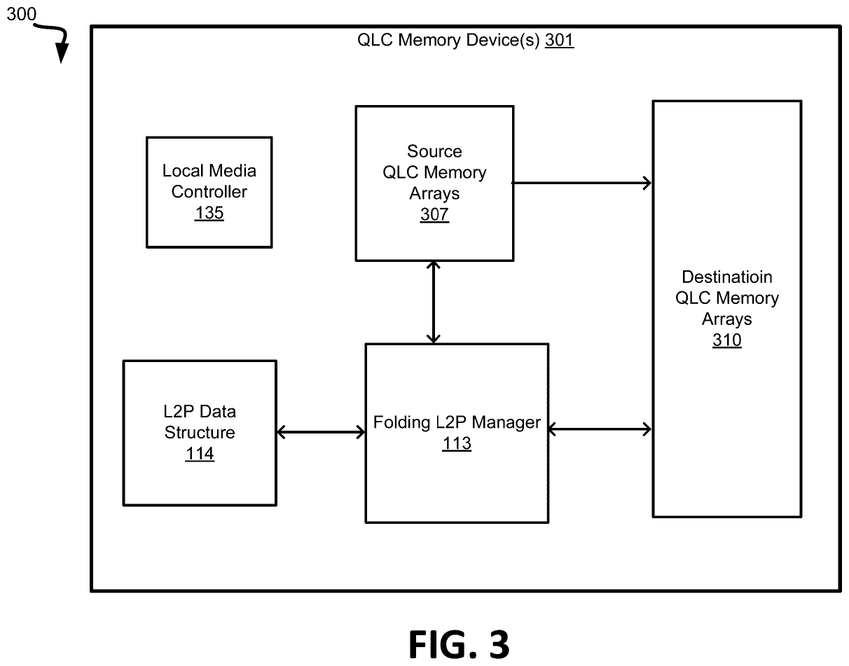

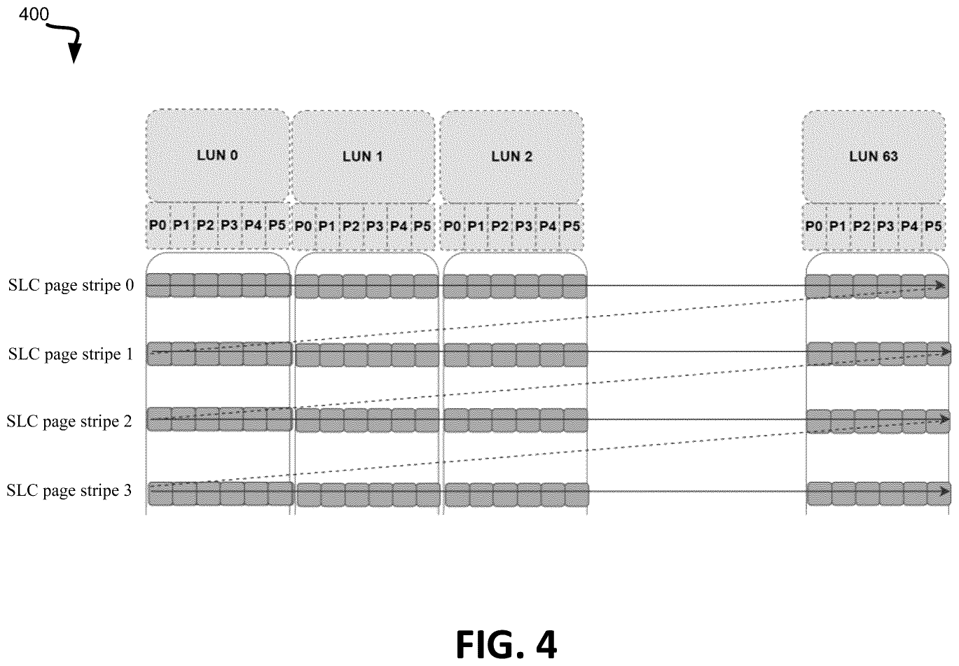

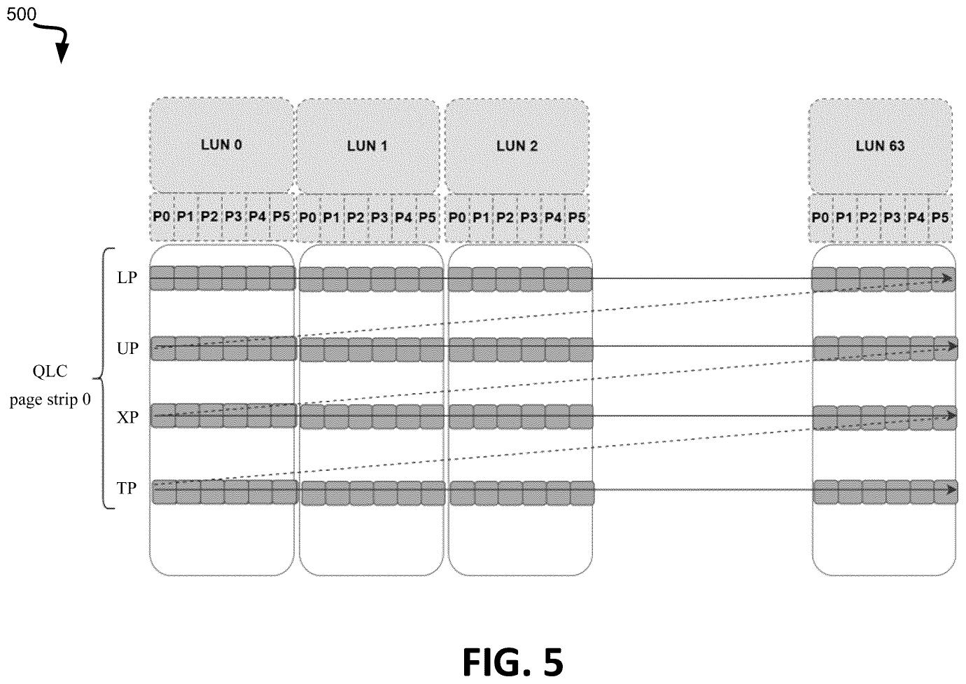

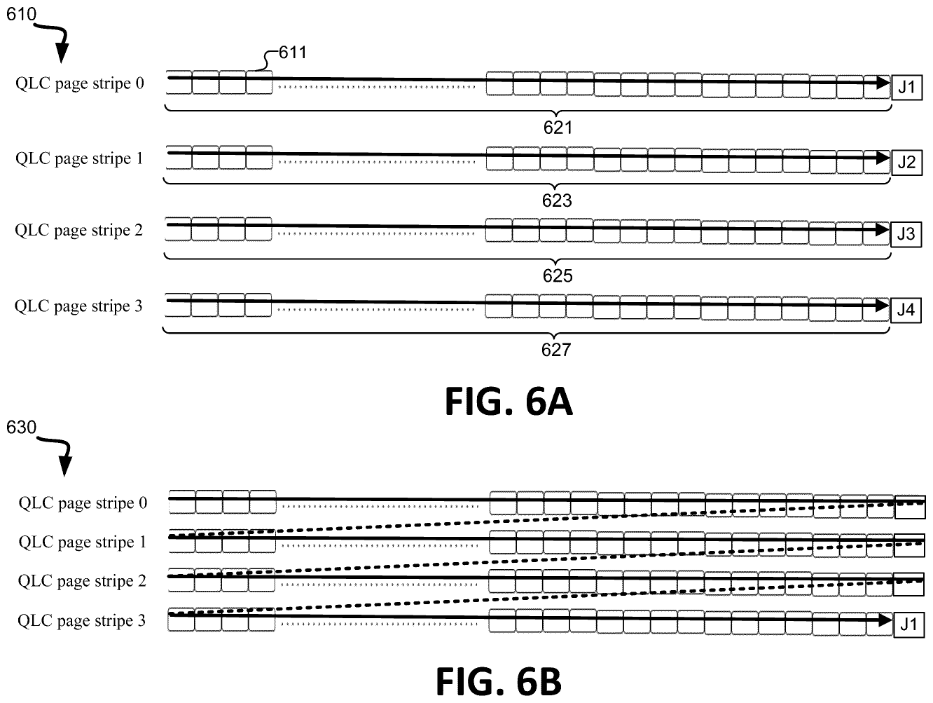

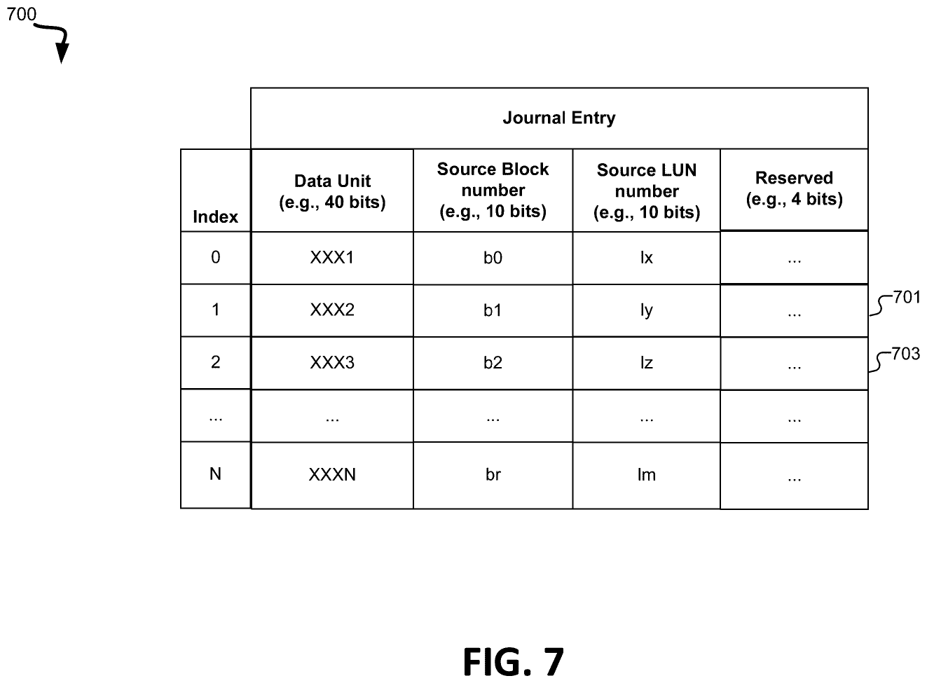

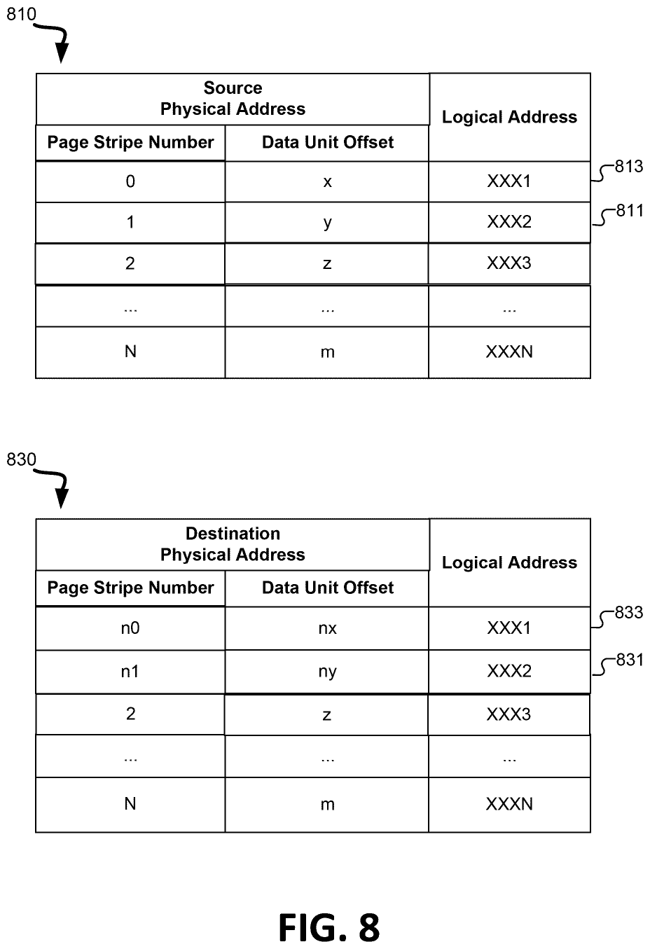

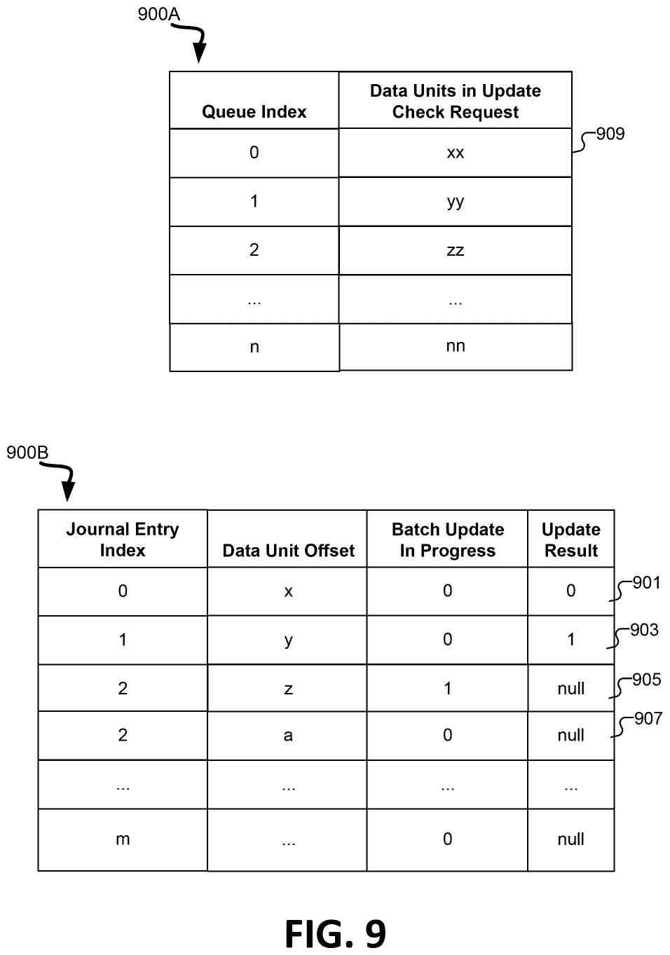

FIG. 2 illustrates an example of performing folding operations from source SLC memory arrays (e.g., SLC page stripes) to destination QLC memory device (e.g., QLC page stripes), and FIG. 4 illustrates example source SLC memory arrays. FIG. 3 illustrates an example of performing folding operations from source QLC memory arrays to destination QLC memory device, and FIG. 5 illustrates example source QLC memory arrays. FIGS. 6A and 6B illustrate example destination QLC memory arrays. FIG. 7 illustrates example journal entries written in the destination QLC memory device. FIG. 8 illustrates example L2P data structure involved in the folding operations. FIG. 9 illustrates example records of batch update processing.

FIG. 2 illustrates a block diagram of a system that performs folding operations from source SLC cache to destination QLC memory device in accordance with some embodiments of the present disclosure. System 200 can represent memory sub-system 110 of FIG. 1. Referring to FIG. 2, system 200 can include single-level cell (SLC) memory arrays 207 (as part of memory device 130), quad-level cell (QLC) memory device 210 (as part of memory device 130), and memory controller 115. Memory controller 115 can include write buffer 201, folding L2P manager 113, L2P data structure 114, and completion notification 213.

Write buffer 201 can store write commands submitted to the memory sub-system by the host system 120 and/or write commands initiated by controller 115 (e.g., garbage collection). Controller 115 can execute the write commands to SLC page stripes in the SLC memory arrays 207. In some embodiments, the QLC memory device 210 can be part of memory devices 130-140. In some embodiments, the SLC memory arrays 207 can be part of memory devices 130-140. In some embodiments, the L2P data structure can be part of controller 115 or memory devices 130-140.

The folding L2P manager 113 can manage the L2P data structure associated with folding operations to migrate data from SLC memory arrays 207 to QLC memory device 210 and also manage the batch update processing in the L2P management. For example, the folding L2P manager 113 can assign a set of SLC page stripes for the folding operation. FIG. 4 illustrates a set of logical units (LUNs) (e.g., LUN0-LUN63), where each LUN includes a set of planes (e.g., P0-P5), where each plane includes a set of blocks (not shown), where each block includes a set of pages, and the pages with the same identifier from each block and each plane and each LUN collectively form a page stripe (e.g., SLC page stripe 0-SLC page stripe 3). Referring to FIG. 4, the folding L2P manager 113 can retrieve the data stored in the SLC page stripes 0-3. The folding L2P manager 113 can retrieve the valid data in the sequential order of SLC page stripe 0, SLC page stripe 1, SLC page stripe 2, SLC page stripe 3 as shown in the arrow direction in FIG. 4.

The folding L2P manager 113 can store the retrieved data to QLC memory device 210. The folding L2P manager 113 can allocate the set of QLC page stripes in QLC memory device 210 in a predefined order. Referring to the set of QLC page stripes 610, 630 shown in FIGS. 6A and 6B, the folding L2P manager 113 can allocate the QLC page stripe 0, the QLC page stripe 1, the QLC page stripe 2, the QLC page stripe 3 in the sequential order of the memory space as shown in the arrow direction in FIGS. 6A and 6B.

While storing the data in the QLC memory device 210, the folding L2P manager 113 can write the journal entries along with the data, where the journal entry records the destination location in the QLC memory device 210 on which the retrieved data is written. As such, the journal entry can be used to identify the logical addresses of the retrieved data and the physical addresses corresponding to the destination QLC memory device 210 (i.e., destination physical addresses). In some implementations, the retrieved data can be divided into a set of write units or taken together as one write unit, and the folding L2P manager 113 can write a journey entry for each write unit to QLC memory device 210.

As shown in FIG. 6A, the retrieved data can be divided into four write units 621, 623, 625, 627, and the folding L2P manager 113 can store the first write unit 621 in QLC page stripe 0 and write the journal entry J1 at the end of QLC page stripe 0; the folding L2P manager 113 can store the second write unit 623 in QLC page stripe 1 and write the journal entry J2 at the end of QLC page stripe 1; the folding L2P manager 113 can store the third write unit 625 in QLC page stripe 2 and write the journal entry J3 at the end of QLC page stripe 2; the folding L2P manager 113 can store the fourth write unit 627 in QLC page stripe 3 and write the journal entry J4 at the end of QLC page stripe 3. As shown in FIG. 6B, the retrieved data can be taken as one write unit, and the folding L2P manager 113 can store the write unit in QLC page stripe 0, QLC page stripe 1, QLC page stripe 2, QLC page stripe 3 (as shown in the connected line ending with an arrow) and write the journal entry J1 at the end of QLC page stripe 3. Although in FIGS. 6A and 6B, each journal entry is shown at the end of the respective QLC page stripe, the journal entry may be stored at other locations of the respective QLC page stripe. Further, as shown in FIGS. 6A and 6B, the retrieved data can be represented by a set of data unit (each data unit represented by a square in FIGS. 6A and 6B), and each write unit may include multiple data units.

To facilitate the management of the L2P data structure, the journal entry can further include fields to identify the source location in the SLC memory arrays 207 from which the data is retrieved. As such, the journal entry can be used to identify the physical addresses corresponding to the source SLC memory arrays 207 (i.e., source physical addresses). The example journal entries are illustrated in FIG. 7.

Referring to FIG. 7, each journal entry of journal entries 700 may be identified by an index. Each journal entry is associated with a QLC page stripe because the folding L2P manager 113 store it in such QLC page stripe. Each journal entry may include multiple fields to identify logical addresses and physical addresses, such as data unit, source block number, source LUN number, etc. For example, the journal entry 701 is identified as index 1 and may be stored in the journal entry J1 in QLC page stripe 0 in the set of QLC page stripes 610 in FIG. 6A. The journal entry 701 may include data unit XXX2. The data unit XXX2 on the QLC page stripe 0 may reflect the destination location 611 in FIG. 6A and represent the physical addresses corresponding to the QLC memory device 210 (i.e., destination physical addresses). The data unit XXX2, when combined with the journal entry index 1 and the QLC page stripe 0, can identify the logical address of the data stored in the data unit XXX2 (e.g., the logical address of data stored in the destination location 611 in FIG. 6A). The journal entry 701 may include source block number 1 and source LUN number y. The combination of source block number 1 and source LUN number y can be used to identify the source location and represent the physical addresses corresponding to the SLC memory arrays 207 (i.e., source physical addresses). Although two fields “source block number” and “source LUN number” in the journal entry are illustrated as an example to identify the source location and represent the source physical addresses, the number of fields and the content of fields that are used to identify the source location and represent the source physical addresses can vary in the journal entry.

Referring back to FIG. 2, the folding L2P manager 113 can keep writing the retrieved data to the QLC memory device 210 and the corresponding journal entries. In one embodiment, when the folding L2P manager 113 determines that writing the retrieved data is completed, the folding L2P manager 113 can perform a L2P update check. The L2P update check determines whether threshold criterion is satisfied to update the L2P data structure 114 maintained by the controller 115 such that the L2P data structure 114 is updated from mapping logical address of the data to source physical addresses to mapping logical address of the data to destination physical addresses.

To determine that writing the retrieved data is completed, the folding L2P manager 113 can receive a request for a folding operation regarding the data, and responsive to determining that the data is stored in the QLC memory device 210, determine that the writing of the retrieved data is completed. Alternatively, the folding L2P manager 113 can determine that a specific amount of data has been written to the QLC memory device 210 and determine that the writing of the retrieved data is completed.

In some implementations, the threshold criterion for the L2P update check may require that the source locations specified in each journal entry of the journal entries associated with the data match corresponding entries in the L2P data structure. For example, the source location may be specified by the source block number 1 and the source LUN number y of the journal entry 701, and the journal entry 701 may be used to identify the logical address of the data stored in the data unit XXX2 as described above, while the logical address of the data stored in the data unit XXX2 may be the same of the logical address XXX2 of the L2P entry 811 of the L2P data structure 810. The folding L2P manager 113 can determine whether the source location specified by the source block number 1 and the source LUN number y of the journal entry 701 matches the source physical address of the L2P entry 811, which is identified by the page stripe number 1 and the data unit offset y. Responsive to determining that the source location specified by the source block number 1 and the source LUN number y of the journal entry 701 matches the source physical address identified by the page stripe number 1 and the data unit offset y of the L2P entry 811, the folding L2P manager 113 may determine that the source location specified in the journal entry 701 match corresponding entries in the L2P data structure 810. The folding L2P manager 113 may make determination similarly on each journal entry of the journal entries associated with the data. Responsive to determining that the source locations specified in each journal entry of the journal entries associated with the data match corresponding entries in the L2P data structure, the folding L2P manager 113 update the L2P data structure 810 to the L2P data structure 830, where the L2P data structure 810 maps the logical address to source physical address and the L2P data structure 830 maps the logical address to destination physical address. As shown in the example of FIG. 8, the L2P data structure 810 may be updated to the L2P data structure 830. For example, the L2P entry 811 of the L2P data structure 810 may be updated to the L2P entry 831 of the L2P data structure 830, and other L2P entries (e.g., L2P entry 813) associated with the data may be updated (e.g., updated to L2P entry 833) as well to map the designation physical address. These updated L2P entries together correspond to the data that is involved in the folding operation and can be referred to as a batch update of the L2P entries, and in such case, the batch of the L2P entries corresponds to the entire retrieved data.

In some implementations, the folding L2P manager 113 may determine that source locations specified in a subset of journal entries associated with the data match corresponding entries in the L2P data structure. Responsive to determining that the source locations specified in each journal entry of the subset of the journal entries associated with the data match corresponding entries in the L2P data structure, the folding L2P manager 113 may update the batch of the L2P entries the L2P data structure 810 to the L2P data structure 830, where the batch of the L2P entries corresponds to partial of the retrieved data. In such cases, the L2P entries that correspond to the rest of the journal entries associated with the data (i.e., source locations unmatched) will not be updated.

As described above, the folding L2P manager 113 may perform the L2P update check, for example, using journal entries stored in the destination memory cells, but other methods are also applicable to perform the L2P update check as long as that it determines whether the data stored in the source memory cells (before migration) is the same as the data stored in the destination memory cells (after migration). During performing the L2P update check, the folding L2P manager 113 may detect an event that affects the performance of the L2P update check and perform an action associated with the event to solve the effect.

In some implementations, the folding L2P manager 113 may maintain a queue to keep track of requests of the L2P update check on the data, wherein the L2P update check may be performed in data granularity of a block stripe, a page stripe, a write unit, a set of data units, etc. An example queue 900A is illustrated in FIG. 9. Referring to FIG. 9, the queue 900A may be stored in a data structure and include a queue index referencing a L2P update check request in the queue, a field identifying one or more data units on which the L2P update check is requested. As examples shown in FIG. 9, the queue entry 909 may reflect that the data unit(s) xx in the request identified by the queue index 0 is in progress on the L2P update check, and the following queue entries are to be processed in the sequential order.

In some implementations, the folding L2P manager 113 may maintain an update record to keep track of the performance and result of the L2P update check, such as a result of performing the L2P update check on a data unit of the data or a set of data units that is associated with a set of journal entries. In some implementations, the folding L2P manager 113 may perform the action associated with the event based on the update record. An example update record 900B is illustrated in FIG. 9.

Referring to FIG. 9, the update record 900B may be stored in a data structure and include a journal entry index referencing a journal entry, a data unit offset identifying one or more data units on which the L2P update check is performed, a field indicating whether a batch update is in progress on the data unit(s), and a field indicating the result of performing the L2P update check on the data unit(s). The journal entry index may be the same as the index of journal entries 700 in FIG. 7. The data unit offset may be same as the data unit offset of the L2P data structure 810, 830 in FIG. 8. The field indicating whether a batch update is in progress (“in-progress field”) on the data unit(s) may be set to ‘1’ when the folding L2P manager 113 begins a L2P update check on the data unit(s) and set to ‘0’ when the folding L2P manager 113 completes or has not begun the L2P update check on the data unit(s). The field indicating the result of performing the L2P update check on the data unit(s) may be set to ‘1’ when the data unit(s) passes the L2P update check, set to ‘0’ when the data unit(s) fails the L2P update check, and set to ‘null’ when performing the L2P update check on the data unit(s) has not been finished.

As examples shown in FIG. 9, the update record entry 901 may reflect that the data unit identified by data unit offset x on journal entry index 0 is not in progress on the L2P update check, and that the data unit has failed the L2P update check (which means that the data unit will not be included in the batch update of the L2P data structure). The update record entry 903 may reflect that the data unit identified by data unit offset y on journal entry index 1 is not in progress on the L2P update check, and that the data unit has passed the L2P update check (which means that the data unit will be included in the batch update of the L2P data structure). The update record entry 905 may reflect that the data unit identified by data unit offset z on journal entry index 2 is in progress on the L2P update check, and that performing the L2P update check on the data unit has not been finished. The update record entry 907 may reflect that the data unit identified by data unit offset a on journal entry index 2 is not in progress on the L2P update check, and that performing the L2P update check on the data unit has not been finished.

In some implementations, the event is an occurrence of uncorrectable error (e.g., uncorrectable ECC). The folding L2P manager 113 may detect that an uncorrectable error occurs during retrieving a first journal entry of the journal entries, and skip performing the L2P update check on one or more data units associated with the first journal entry and resume the L2P update check on the rest of journal entries. In an illustrative example, the folding L2P manager 113 may retrieve the journal entry 703 and determine that an uncorrectable error occurs during retrieving such that it cannot decode the content of the journal entry 703. The journal entry 703 may be specified in the update check request identified by queue index 0 in queue entry 909 in FIG. 9, or correspond to multiple update record entries, for example, update record entry 905, 907 in FIG. 9. In some implementations, the folding L2P manager 113 may detect the uncorrectable error occurs when retrieving the journal entry 703 that corresponds to the update record entry 905 as the L2P update check is in progress. The folding L2P manager 113 may skip performing the L2P update check on data units specified in the update check request that is identified as queue index 0 (e.g., data units xx) or data units associated with the journal entry that is identified as journal entry index 2 (e.g., data units identified by data unit offset z, a). In some implementations, the folding L2P manager 113 may modify the update result of the update record entry 905, 907 to ‘0’ or keep the update result as ‘null.’ The folding L2P manager 113 may resume the L2P update check on the update check request following the skipped request (e.g., identified by queue index 1) or on the journal entry following the skipped journal entry (e.g., identified as journal entry index 3 (not shown)) and modify the in-progress field as it continues performing the L2P update check. As such, the L2P entries that are associated with data units on journal entry index 2 will not be updated in the L2P data structure. The corresponding data of these data units is presumedly still stored in the source memory cells and can be available to perform future folding operations.

In some implementations, the event is an occurrence of a controlled power down. The controlled power down provides a limited amount of backup power to finish certain operations in the event of power down. For example, the system may perform an emergency system operation, in which a component of a system detects a sudden drop of the power supply voltage, sends a notification across the system before the power supply is completely compromised due to the power loss event, and provides backup power (e.g., by non-volatile media devices can include capacitors) to the components of the system when the primary source of power is lost.

The folding L2P manager 113 may detect that a controlled power down occurs during performing the L2P update check on one or more data units associated with a first journal entry of the journal entries, use a backup power to continue performing the L2P update check on the one or more data units associated with the first journal entry, and upon detecting a power up event, resume the L2P update check on the rest of journal entries. In an illustrative example, the folding L2P manager 113 may retrieve the journal entry 703 and determine that a controlled power down occurs during retrieving. The journal entry 703 may be specified in the update check request identified by queue index 0 in queue entry 909 in FIG. 9, or correspond to multiple update record entries, for example, update record entry 905, 907 in FIG. 9. The folding L2P manager 113 may detect the uncorrectable error occurs when retrieving the journal entry 703 that corresponds to the update record entry 905 as the L2P update check is in progress. In one implementation, the folding L2P manager 113 may use a backup power to continue performing the L2P update check on data units specified in the update check request that is identified as queue index 0 (e.g., data units xx) or data units (e.g., data units identified by data unit offset z, a) associated with the journal entry that is identified as journal entry index 2. In one implementation, the folding L2P manager 113 may delete the update check request that has been finished in the queue or move up the queue pointer to the following update check request. In one implementation, the folding L2P manager 113 may modify the update result of the update record entry 905, 907 based on the result of performing the L2P update check on the data units (e.g., modify the update result to ‘0’ or ‘1’) and modify the in-progress field of the update record entry 905, 907 to ‘0’ as performing the L2P update check on these data units is finished. In another implementation, the folding L2P manager 113 may use a backup power to continue performing the L2P update check on the data unit (e.g., data unit identified by data unit offset z) associated with the update record entry 905, modify the update result of the update record entry 905 based on the result of performing the L2P update check on the data unit (e.g., modify the update result to ‘0’ or ‘1’), and modify the in-progress field of the update record entry 905 to ‘0’ as performing the L2P update check on this data unit is finished.

Responsive to detecting a power up event, the folding L2P manager 113 may resume the L2P update check on the update check request following the request has been finished using the backup power (e.g., identified by queue index 1) or on other journal entries (e.g., identified as journal entry index 3 (not shown), m, etc.). As such, the folding L2P manager 113 can perform the L2P update check on data units associated with the journal entries as if it were undisrupted by the controlled power down.

In some implementations, the event is an occurrence of an asynchronous power loss (APL). The asynchronous power loss refers to the power loss occurs while there is still “in flight” data that has been either requested or transmitted through components of the system or pending in a component of the system to be written or retrieved and there is insufficient power-sustaining time to permit the systems to complete the pending operations. For example, the system may detect a sudden drop of the power supply voltage and send a notification across the system to allow the components to record before the power supply is completely compromised due to the power loss event.

The folding L2P manager 113 may detect that an asynchronous power loss occurs during performing the L2P update check on one or more data units associated with a first journal entry of the journal entries, record the first journal entry (such that the first journal entry may be retrieved from a location in the array of destination memory cells upon detecting a power on event), and upon detecting a power on event, resume the L2P update check on the first journal entry. In an illustrative example, the folding L2P manager 113 may retrieve the journal entry 703 and determine that an asynchronous power loss occurs during retrieving. The journal entry 703 may be specified in the update check request identified by queue index 0 in queue entry 909 in FIG. 9, or correspond to multiple update record entries, for example, update record entry 905, 907 in FIG. 9. The folding L2P manager 113 may detect the uncorrectable error occurs when retrieving the journal entry 703 that corresponds to the update record entry 905 as the L2P update check is in progress. In one implementation, the folding L2P manager 113 may keep the queue entry 909 in the queue such that the update check request in the queue entry 909 will be reprocessed when the power supply is on. In one implementation, the folding L2P manager 113 may record the update record entry 905 by keeping the in-progress field as ‘1’ indicating that the L2P update check needs to be reperformed on the data units identified in the update record entry 905 when the power supply is on. In one implementation, the folding L2P manager 113 may need to reperform the L2P update check on all update record entries (e.g., update record entry 905, 907) that are associated with the journal entry 703, and may keep or modify the in-progress field of the update record entry 905, 907 to ‘1’ indicating that the L2P update check needs to be reperformed on the data units identified in the update record entry 905, 907 when the power supply is on.

Responsive to detecting a power on event, the folding L2P manager 113 may resume the L2P update check on the update check request that is processed at the power loss (e.g., identified by queue index 0) or on the journal entries that are associated with update record entry having in-progress field with a value ‘1’ (e.g., update record entry 905, 907). As such, the folding L2P manager 113 can perform the L2P update check on data units associated with the journal entries as by reperforming the L2P update check on the journal entries that are affected by the power loss.

The folding L2P manager 113 may perform a batch update to update a batch of the L2P entries in the L2P data structure for all the L2P entries that are associated with the update record entry having the update result with a value ‘1.’

FIG. 3 illustrates a block diagram of a system that performs folding operations from source QLC memory arrays to destination QLC memory arrays in accordance with some embodiments of the present disclosure. System 300 can represent memory device 130 of FIG. 1. Referring to FIG. 3, system 300 can be a quad-level cell (QLC) memory device 301 (as part of memory devices 130-140). The QLC memory device 301 can include a local media controller 135, source QLC memory arrays 307, folding L2P manager 113, L2P data structure 114, and destination QLC memory arrays 310.

The local media controller 135 can store write commands submitted to the memory device 301 by the host system 120 and/or write commands initiated by controller 115 (e.g., garbage collection). The local media controller 135 can execute the write commands to QLC page stripes in the QLC memory arrays 307. In some embodiments, the L2P data structure 114 can be part of local media controller 135.

The folding L2P manager 113 can manage the L2P data structure associated with the folding operations to migrate data from QLC memory arrays 307 to QLC memory arrays 310 and also manage the batch update processing in the L2P management. For example, the folding L2P manager 113 can assign a set of QLC page stripes for the folding operation. FIG. 5 illustrates a set of logical units (LUNs) (e.g., LUN0-LUN63), where each LUN includes a set of planes (e.g., P0-P5), where each plane includes a set of blocks (not shown), where each block includes a set of pages, and the pages with the same identifier from each block and each plane and each LUN collectively form a page stripe (e.g., QLC page stripe 0 including LP, UP, XP, and TP). Referring to FIG. 5, the folding L2P manager 113 can retrieve the data stored in the QLC page stripe 0, which comprises LP, UP, XP, and TP. The folding L2P manager 113 can retrieve the data in the sequential order of LP, UP, XP, and TP as shown in the arrow direction in FIG. 5.

Similarly, as described above with respect of FIG. 2, the folding L2P manager 113 can store the retrieved data to QLC memory device 210. The folding L2P manager 113 can allocate the set of QLC page stripes in QLC memory device 210 in a predefined order. While storing the data in the QLC memory device 210, the folding L2P manager 113 can write the journal entries along with the data, where the journal entry records the destination location in the QLC memory device 210 on which the retrieved data is written. When the L2P manager 113 determines that writing the retrieved data is completed, the folding L2P manager 113 can perform a L2P update check. The L2P update check determines whether threshold criterion is satisfied to update the L2P data structure 114 maintained by the controller 115 such that the L2P data structure 114 is updated from mapping logical address of the data to source physical addresses to mapping logical address of the data to destination physical addresses. Responsive to determining that the source locations specified in each journal entry of the journal entries associated with the data match corresponding entries in the L2P data structure, the folding L2P manager 113 update the L2P data structure 810 to the L2P data structure 830, where the L2P data structure 810 maps the logical address to source physical address and the L2P data structure 830 maps the logical address to destination physical address. During performing the L2P update check, the folding L2P manager 113 may detect an event that affects the performance of the L2P update check and perform an action associated with the event to solve the effect. In some implementations, the folding L2P manager 113 may keep track of the performance of the L2P update check and record, in an update record, a result of performing the L2P update check on a data unit of the data units of the data. In some implementations, the folding L2P manager 113 may record a result of performing the L2P update check on a set of data units that is associated with a set of journal entries. In some implementations, the folding L2P manager 113 may perform the action associated with the event based on the update record.

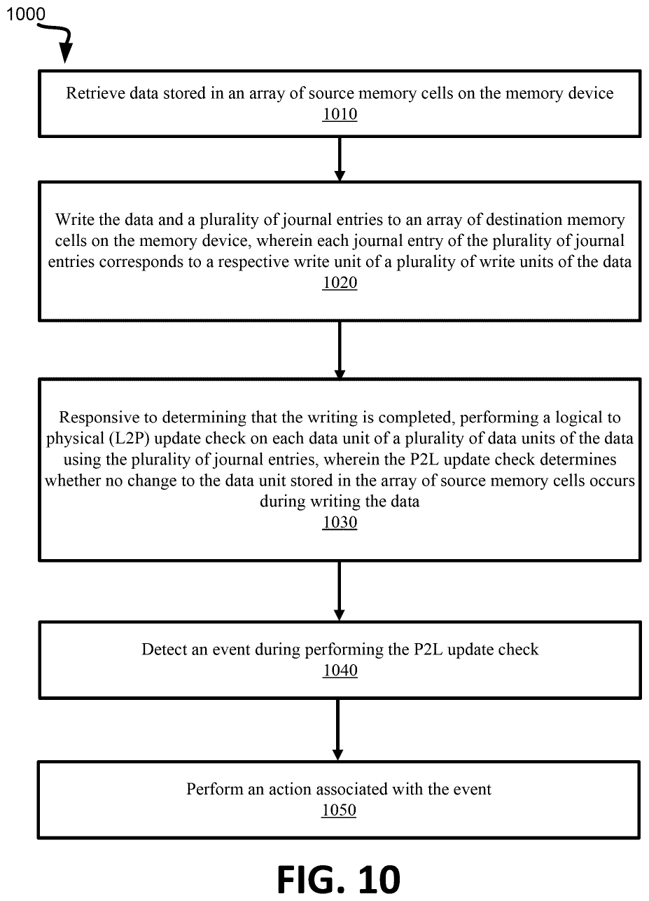

FIG. 10 is a flow diagram of an example method to manage the folding operations in accordance with some embodiments of the present disclosure. The method 1000 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 1000 is performed by the folding L2P manager 113 of FIGS. 1-3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 1010, the processing device may retrieve data stored in an array of source memory cells (e.g., SLC page stripes 0-3 in FIG. 4 or QLC page stripe 0 in FIG. 5) on the memory device (e.g., SLC memory arrays 207 in FIG. 2 or QLC memory arrays 307 in FIG. 3). In some implementations, the data is retrieved in a sequential order of valid data stored in the set of source management units. In some implementations, the processing device may receive a request to perform a folding operation to migrate the data stored in a set of source management units to a set of destination management units, and responsive to receiving the request, retrieve the data stored in the set of source management units.

At operation 1020, the processing device may write the data and corresponding journal entries to an array of destination memory cells on the memory device, where each journal entry of the journal entries corresponds to a respective write unit (e.g., write unit 621, 623, 625, or 627 in FIG. 6A or write unit in FIG. 6B) of a plurality of write units of the data. In some implementations, the processing device may store the data and the journal entries (e.g., journal entries J1-J4 in FIG. 6A or journal entry J1 in FIG. 6B) in the array of destination memory cells (e.g., QLC page stripe 0 in FIG. 6A or QLC page stripes 0-3 in FIG. 6B) on the memory device (e.g., QLC memory devices 210 in FIG. 2 or QLC memory arrays 310 in FIG. 3). In some implementations, the processing device may perform a two pass programming operation to program the data on the set of destination management units, where the two pass programming operation comprises performing a first program pass to apply a first set of voltages and performing a second program pass to apply a second set of voltages.

In some implementations, each journal entry of the plurality of journal entries (e.g., journal entries 700 in FIG. 7) specifies one or more source locations of corresponding data stored in the array of source memory cells. In some implementations, each journal entry of the plurality of journal entries specifies the one or more source locations using a first field (e.g., the source LUN number in journal entries 700) indicating a logical unit number and a second field (e.g., the source block number in journal entries 700) indicating a block offset in the logical unit. In some implementations, each journal entry of the plurality of journal entries specifies one or more destination locations of corresponding data stored in the array of destination memory cells. In some implementations, each write unit comprises a single page stripe or multiple page stripes, wherein the data comprises a plurality of data units, and wherein each write unit comprises a subset of the plurality of data units.

At operation 1030, responsive to determining that the writing is completed, the processing device may perform a logical to physical (L2P ) update check on each data unit of a plurality of data units of the data using the plurality of journal entries (e.g., journal entries 700 in FIG. 7), where the L2P update check determines whether no change to the data unit stored in the array of source memory cells occurs during writing the data. In some implementations, to perform a L2P update check, the processing device may retrieve the journal entries (e.g., journal entries J1-J4 in FIG. 6A or journal entry J1 in FIG. 6B) stored in the array of destination memory cells (e.g., QLC page stripe 0 in FIG. 6A or QLC page stripes 0-3 in FIG. 6B) and determine, for each journal entry of the plurality of journal entries, whether a source location specified in the journal entry matches a corresponding L2P entry in a logical to physical (L2P ) data structure, where the L2P data structure maps one or more logical addresses of the data to one or more source physical addresses. In some implementations, to determine that each source location specified in the plurality of journal entries matches the corresponding L2P entry in the L2P data structure, the processing device may determine whether the one or more source locations specified in the plurality of journal entries match the one or more source physical addresses in the L2P data structure.

At operation 1040, the processing device may detect an event during performing the L2P update check, and at operation 1050, the processing device may perform an action associated with the event. In some implementations, the processing device may record, in a data structure (e.g., update record 900B in FIG. 9), a result of performing the L2P update check on a data unit of a plurality of data units of the data using the plurality of journal entries.

In some implementations, the processing device may detect that an uncorrectable error occurs during retrieving a first journal entry of the plurality of journal entries. In some implementations, the processing device may skip performing the L2P update check on one or more data units associated with the first journal entry and resuming the L2P update check after skipping. In some implementations, the one or more data units associated with the first journal entry are kept in the array of source memory cells for future retrieving.

In some implementations, the processing device may detect that a controller power down occurs during performing the L2P update check on one or more data units associated with a first journal entry of the plurality of journal entries. In some implementations, the processing device may use a backup power to continue performing the L2P update check on the one or more data units associated with the first journal entry, and upon detecting a power up event, resume the L2P update check on a second journal entry of the plurality of journal entries, where the second journal entry is written most recently following the first journal entry among the plurality of journal entries.

In some implementations, the processing device may detect that an asynchronous power loss occurs during performing the L2P update check on one or more data units associated with a first journal entry of the plurality of journal entries. In some implementations, the processing device may record the first journal entry, and upon detecting a power on event, resume the L2P update check on the first journal entry. In some implementations, the first journal entry may be recorded in a queue data structure (e.g., queue 900A in FIG. 9).

In some implementations, responsive to determining that each source location specified in the plurality of journal entries matches the corresponding L2P entry in the L2P data structure, the processing device may update the L2P data structure from mapping the one or more logical addresses of the data to the one or more source physical addresses to mapping the one or more logical addresses of the data to one or more destination physical addresses. In some implementations, the L2P data structure comprises a plurality of L2P entries, wherein updating the L2P data structure comprises updating a batch of L2P entries of the plurality of L2P entries from mapping the one or more logical addresses of the data to the one or more source physical addresses to mapping the one or more logical addresses of the data to one or more destination physical addresses, and wherein the batch of L2P entries correspond to the data. In some implementations, responsive to updating the L2P data structure, the processing device may release memory space that stores the data in the array of source memory cells.

In some implementations, responsive to determining that each source location specified in the plurality of journal entries does not match the corresponding L2P entry in the L2P data structure, the processing device may keep the L2P data structure unchanged. In some implementations, responsive to determining that, for a set of journal entries of the plurality of journal entries, the source location specified in the journal entry matches the corresponding L2P entry in the L2P data structure, the processing device may update the L2P data structure only for the set of journal entries.

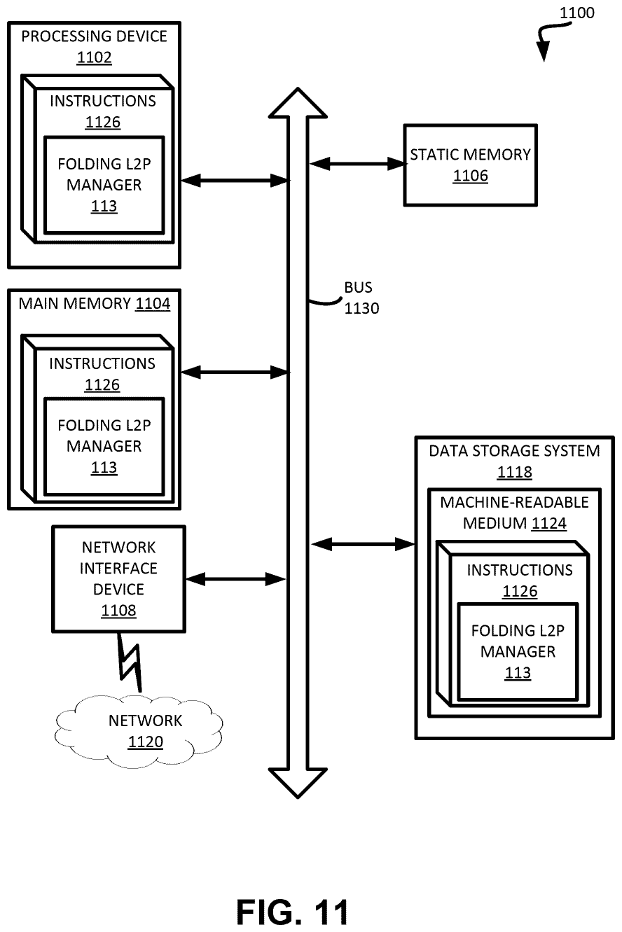

FIG. 11 illustrates an example machine of a computer system 1100 within which a set of instructions, for causing the machine to perform any one or more of the methodologies discussed herein, can be executed. In some embodiments, the computer system 1100 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the folding L2P manager 113 of FIGS. 1-3). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM) or RDRAM, etc.), a static memory 1106 (e.g., flash memory, static random access memory (SRAM), etc.), and a data storage system 1118, which communicate with each other via a bus 1130.

Processing device 1102 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 can also be one or more special-purpose processing devices such as an application specific integrated circuit (ASIC), a field programmable gate array (FPGA), a digital signal processor (DSP), network processor, or the like. The processing device 1102 is configured to execute instructions 1126 for performing the operations and steps discussed herein. The computer system 1100 can further include a network interface device 1108 to communicate over the network 1120.

The data storage system 1118 can include a machine-readable storage medium 1124 (also known as a computer-readable medium) on which is stored one or more sets of instructions 1126 or software embodying any one or more of the methodologies or functions described herein. The instructions 1126 can also reside, completely or at least partially, within the main memory 1104 and/or within the processing device 1102 during execution thereof by the computer system 1100, the main memory 1104 and the processing device 1102 also constituting machine-readable storage media. The machine-readable storage medium 1124, data storage system 1118, and/or main memory 1104 can correspond to the memory sub-system 110 of FIG. 1.

In one embodiment, the instructions 1126 include instructions to implement functionality corresponding to a component (e.g., the folding L2P manager 113 of FIGS. 1-3). While the machine-readable storage medium 1124 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
retrieving data stored in an array of source memory cells on the memory device;
writing the data and a plurality of journal entries to an array of destination memory cells on the memory device, wherein each journal entry of the plurality of journal entries corresponds to a respective write unit of a plurality of write units of the data;
responsive to determining that the writing is completed, performing a logical to physical (L2P) update check on each data unit of a plurality of data units of the data using the plurality of journal entries, wherein the L2P update check determines whether no change to the data unit stored in the array of source memory cells occurs during writing the data;
detecting an event during performing the L2P update check; and
performing an action associated with the event.

2. The system of claim 1, wherein performing the L2P update check further comprises:
retrieving the plurality of journal entries; and
determining, for each journal entry of the plurality of journal entries, whether a source location specified in the journal entry matches a corresponding logical to physical (L2P) entry in a L2P data structure, wherein the L2P data structure maps one or more logical addresses of the data to one or more source physical addresses.

3. The system of claim 2, the operations further comprise:
responsive to determining that each source location specified in the plurality of journal entries matches the corresponding L2P entry in the L2P data structure, updating the L2P data structure from mapping the one or more logical addresses of the data to the one or more source physical addresses to mapping the one or more logical addresses of the data to one or more destination physical addresses, wherein the L2P data structure comprises a plurality of L2P entries, and wherein updating the L2P data structure comprises updating a batch of L2P entries of the plurality of L2P entries from mapping the one or more logical addresses of the data to the one or more source physical addresses to mapping the one or more logical addresses of the data to one or more destination physical addresses, and wherein the batch of L2P entries corresponds to the data.

4. The system of claim 1, wherein each journal entry of the plurality of journal entries specifies the one or more source locations, and wherein each journal entry of the plurality of journal entries specifies one or more destination locations of corresponding data stored in the array of destination memory cells.

5. The system of claim 1, wherein detecting the event during performing the L2P update check further comprises detecting that an uncorrectable error occurs during retrieving a first journal entry of the plurality of journal entries, and
wherein performing the action associated with the event further comprises:
skipping performing the L2P update check on one or more data units associated with the first journal entry.

6. The system of claim 5, wherein the one or more data units associated with the first journal entry are kept in the array of source memory cells for future retrieving.

7. The system of claim 1, wherein detecting the event during performing the L2P update check further comprises detecting that a controller power down occurs during performing the L2P update check on one or more data units associated with a first journal entry of the plurality of journal entries, and
wherein performing the action associated with the event further comprises:
using a backup power to continue performing the L2P update check on the one or more data units associated with the first journal entry; and
upon detecting a power up event, resuming the L2P update check on a second journal entry of the plurality of journal entries.

8. The system of claim 1, wherein detecting the event during performing the L2P update check further comprises detecting that an asynchronous power loss occurs during performing the L2P update check on one or more data units associated with a first journal entry of the plurality of journal entries, and
wherein performing the action associated with the event further comprises:
recording the first journal entry; and
upon detecting a power on event, resuming the L2P update check on the first journal entry.

9. The system of claim 1, wherein the operations further comprise:
recording a result of performing the L2P update check on a data unit of a plurality of data units of the data using the plurality of journal entries.

10. The system of claim 1, wherein each write unit comprises a single page stripe or multiple page stripes, wherein the data comprises a plurality of data units, and wherein each write unit comprises a subset of the plurality of data units.

11. A method, comprising:
retrieving, by a processing device, data stored in an array of source memory cells on a memory device;
writing the data and a plurality of journal entries to an array of destination memory cells on the memory device, wherein each journal entry of the plurality of journal entries corresponds to a respective write unit of a plurality of write units of the data;
responsive to determining that the writing is completed, performing a logical to physical (L2P) update check on each data unit of a plurality of data units of the data using the plurality of journal entries, wherein the L2P update check determines whether no change to the data unit stored in the array of source memory cells occurs during writing the data;
detecting an event during performing the L2P update check; and
performing an action associated with the event.

12. The method of claim 11, wherein performing the L2P update check further comprises:
retrieving the plurality of journal entries; and
determining, for each journal entry of the plurality of journal entries, whether a source location specified in the journal entry matches a corresponding logical to physical (L2P) entry in a L2P data structure, wherein the L2P data structure maps one or more logical addresses of the data to one or more source physical addresses.

13. The method of claim 11, wherein detecting the event during performing the L2P update check further comprises detecting that an uncorrectable error occurs during retrieving a first journal entry of the plurality of journal entries, and
wherein performing the action associated with the event further comprises:
skipping performing the L2P update check on one or more data units associated with the first journal entry.

14. The method of claim 11, wherein detecting the event during performing the L2P update check further comprises detecting that a controller power down occurs during performing the L2P update check on one or more data units associated with a first journal entry of the plurality of journal entries, and
wherein performing the action associated with the event further comprises:
using a backup power to continue performing the L2P update check on the one or more data units associated with the first journal entry; and
upon detecting a power up event, resuming the L2P update check on a second journal entry of the plurality of journal entries.

15. The method of claim 11, wherein detecting the event during performing the L2P update check further comprises detecting that an asynchronous power loss occurs during performing the L2P update check on one or more data units associated with a first journal entry of the plurality of journal entries, and
wherein performing the action associated with the event further comprises:
recording the first journal entry; and
upon detecting a power on event, resuming the L2P update check on the first journal entry.

16. The method of claim 11, further comprising:
recording a result of performing the L2P update check on a data unit of a plurality of data units of the data using the plurality of journal entries.

17. A non-transitory computer-readable storage medium comprising instructions that, when executed by a processing device, cause the processing device to perform operations comprising:
retrieving data stored in an array of source memory cells on a memory device;
writing the data and a plurality of journal entries to an array of destination memory cells on the memory device, wherein each journal entry of the plurality of journal entries corresponds to a respective write unit of a plurality of write units of the data;
responsive to determining that the writing is completed, performing a logical to physical (L2P) update check on each data unit of a plurality of data units of the data using the plurality of journal entries, wherein the L2P update check determines whether no change to the data unit stored in the array of source memory cells occurs during writing the data;
detecting an event during performing the L2P update check; and
performing an action associated with the event.

18. The non-transitory computer-readable storage medium of claim 17, wherein detecting the event during performing the L2P update check further comprises detecting that an uncorrectable error occurs during retrieving a first journal entry of the plurality of journal entries, and
wherein performing the action associated with the event further comprises:
skipping performing the L2P update check on one or more data units associated with the first journal entry.

19. The non-transitory computer-readable storage medium of claim 17, wherein detecting the event during performing the L2P update check further comprises detecting that a controller power down occurs during performing the L2P update check on one or more data units associated with a first journal entry of the plurality of journal entries, and
wherein performing the action associated with the event further comprises:
using a backup power to continue performing the L2P update check on the one or more data units associated with the first journal entry; and
upon detecting a power up event, resuming the L2P update check on a second journal entry of the plurality of journal entries.

20. The non-transitory computer-readable storage medium of claim 17, wherein detecting the event during performing the L2P update check further comprises detecting that an asynchronous power loss occurs during performing the L2P update check on one or more data units associated with a first journal entry of the plurality of journal entries, and
wherein performing the action associated with the event further comprises:
recording the first journal entry; and
upon detecting a power on event, resuming the L2P update check on the first journal entry.
